(19) United States
(12) Patent Application Publication
(10) Pub. No.: US 2021/0133875 A1
(43) Pub. Date: May 6, 2021

(54) COMPREHENSIVE BUYING, SELLING, TRADING, TRACKING, VERIFICATION, VALIDATION, TOKENIZATION AND FINANCIAL SERVICES USING BLOCKCHAIN

(71) Applicant: BLOCK 30 Holding Co. LLC, Middletown, DE (US)

(72) Inventors: Brian McLaren Foote, Del Mar, CA (US); Adam Wolfe, Sherman Oaks, CA (US); Jeff Hinshaw, San Diego, CA (US)

(21) Appl. No.: 17/084,251

(22) Filed: Oct. 29, 2020

Related U.S. Application Data
(60) Provisional application No. 63/014,544, filed on Apr. 23, 2020.
(60) Provisional application No. 62/927,938, filed on Oct. 30, 2019.

(51) Int. Cl. G06Q 40/04; G06Q 10/10; G06Q 20/38; G06Q 20/36; G06Q 20/12; G06F 9/54

(52) U.S. Cl. CPC G06Q 40/04; G06Q 10/10; G06Q 20/389; G06Q 30/0185; G06Q 20/1235; G06F 9/547; G06Q 2220/00; G06Q 20/3672

(57) ABSTRACT

A method for generating specialized tokens for a bundled asset that includes a plurality of assets can include the step of a user inputting data defining a bundled portfolio including one or more of a trading symbol, a token name and an initial supply into a host database of a host system to establish a smart contract token. The plurality of assets within the bundled asset can be tokenized and verified by utilizing a blockchain. A host system for generating specialized tokens for a bundled asset including a plurality of assets can include one or more of a host processor, a host database, and a non-transitory computer-readable medium comprising code, executable by the host processor. The host system can be configured to track the bundled portfolio with a smart contract. The bundled portfolio can include one or more non-currency assets

### RELATED APPLICATIONS

This application claims priority on U.S. Provisional Application Ser. No. 62/927,938, filed on Oct. 30, 2019, and entitled “COMPREHENSIVE BUYING, SELLING, TRADING, TRACKING, VERIFICATION, VALIDATION, TOKENIZATION AND FINANCIAL SERVICES USING BLOCKCHAIN” and U.S. Provisional Application Ser. No. 63/014,544, filed on Apr. 23, 2020, and entitled “COMPREHENSIVE BUYING, SELLING, TRADING, TRACKING, VERIFICATION, VALIDATION, TOKENIZATION AND FINANCIAL SERVICES USING BLOCKCHAIN”. As far as permitted, the contents of U.S. Provisional Application Ser. No. 62/927,938 and U.S. Provisional Application Ser. No. 63/014,544, are incorporated in their entirety herein by reference.

### BACKGROUND

Systems utilizing cryptography have advantages over other verification, tracking and financial services systems. For example, tokenized asset transfers can also be faster than conventional asset transfers. Because tokenized assets use blockchains, these assets are often trusted since blockchains are immutable records of transactions.

The process of verifying ownership of assets is widely varied and complicated by globally diverse methods of data collection. The immutability of blockchain data provides a reliable store of information. Other systems have attempted to tackle disparate blockchain use cases as one-off solutions. However, none has been successful using a comprehensive solution for all of these processes. Therefore, there is a need to leverage blockchain immutability to prove asset ownership and the provenance of goods globally in a user-friendly application-based ecosystem.

### SUMMARY

The present invention is directed toward a method for generating specialized tokens for a bundled asset that can include a plurality of assets. In various embodiments, the method can include the step of a user inputting data defining a bundled portfolio including one or more of a trading symbol, a token name and an initial supply into a host database of a host system to establish a smart contract token. The plurality of assets within the bundled asset can each be tokenized and verified utilizing a blockchain.

In one embodiment, the method can include the step of tracking the bundled portfolio with a smart contract.

In some embodiments, the bundled portfolio can include a plurality of different types of assets.

In various embodiments, the method can include the step of a user determining a price for the bundled portfolio into the host system.

In certain embodiments, the method can include the step of the user determining a weighting of the bundled portfolio into the host system.

In some embodiments, the method can include the step of the user inputting one or more smart contract addresses for any digital assets included in the bundled portfolio into the host system.

In various embodiments, the method can include the step of the user inputting one or more API web addresses for real-time pricing of each of the plurality of assets into the host system.

In certain embodiments, the method can include the step of deploying the smart contract token to the blockchain.

In some embodiments, the method can include the step of transferring the smart contract token to a third-party financial exchange.

The present invention is also directed toward a host system for generating specialized tokens for a bundled asset that can include a plurality of assets. The host system can include one or more of a host processor, a host database, and a non-transitory computer-readable medium comprising code, executable by the host processor.

In some embodiments, the host system can be configured to allow a user to input data defining a bundled portfolio including one or more of a trading symbol, a token name and an initial supply into the host database of the host system to establish a smart contract token. The plurality of assets within the bundled asset can each be tokenized and verified by utilizing a blockchain.

In some embodiments, the host system can be configured to track the bundled portfolio with a smart contract.

In certain embodiments, the bundled portfolio can include one or more non-currency assets.

In various embodiments, the host system can be configured to allow the user to determine a price for the bundled portfolio and set the price for the bundled portfolio into the host system.

In some embodiments, the host system can be configured to allow the user to determine a weighting of the bundled portfolio into the host system.

In certain embodiments, the host system can be configured to allow the user to input one or more smart contract addresses for any digital assets included in the bundled portfolio into the host system.

In various embodiments, the host system can be configured to allow the user to input one or more API web addresses for real-time pricing of each of the plurality of assets into the host system.

In some embodiments, the host system can be configured to deploy the smart contract token to the blockchain.

In certain embodiments, the host system can be configured to transfer the smart contract token to a third-party financial exchange.

In various embodiments, the plurality of assets can include at least one digital asset.

The present invention is also directed toward a host system for generating specialized tokens for a bundled asset that includes a plurality of assets. In certain embodiments, the host system can include a host processor, a host database, and a non-transitory computer-readable medium comprising code, executable by the host processor, for implementing a method.

In various embodiments, the method can include a user inputting data into the host database of the host system regarding the bundled asset including information regarding one or more of: the specific assets included in the bundled asset, a trading symbol for the bundled asset, a token name for the bundled asset, and a quantity of an initial supply of tokens, the data establishing a smart contract token, tracking the bundled asset with a smart contract, the user identifying the trading symbol for the bundled portfolio into the host system, the user determining a price for the bundled portfolio into the host system, the user determining a weighting of the bundled portfolio into the host system, the user inputting one or more smart contract addresses for any digital assets included in the bundled portfolio into the host system, the user inputting one or more API web addresses for real-time pricing of each of the plurality of assets into the host system, deploying the smart contract token to the blockchain, and/or transferring the smart contract token to a third-party financial exchange.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is block diagram of one embodiment of an integrated ecosystem of financial services utilizing blockchain technology;

FIG. 2 is a flow chart depicting one embodiment of a method for authenticating the origin of property of a seller;

FIG. 3 is a flow chart depicting one embodiment of a method for verifying the title of property of a seller; and

FIG. 4 is a flow chart depicting one embodiment of a method for generating specialized tokens for a bundled asset including one or more asset types.

While embodiments of the present invention are susceptible to various modifications and alternative forms, specifics thereof have been shown by way of example and drawings, and are described in detail herein. It is understood, however, that the scope herein is not limited to the particular embodiments described. On the contrary, the intention is to cover modifications, equivalents, and alternatives falling within the spirit and scope herein.

### DESCRIPTION

Embodiments of the present invention are described herein in the context of a comprehensive buying, selling, trading, tracking, verification, validation, tokenization and financial services using blockchain technology. More specifically, the immutability of blockchain technology is utilize to improve particular financial service systems and methods including authenticating the origin of property of a seller, verifying the title of property of a seller, and generating specialized tokens for bundled assets including one or more asset types.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar reference indicators will be used throughout the drawings and the following detailed description to refer to the same or like parts.

In the interest of clarity, not all of the routine features of the implementations described herein are shown and described. It will, of course, be appreciated that in the development of any such actual implementations, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

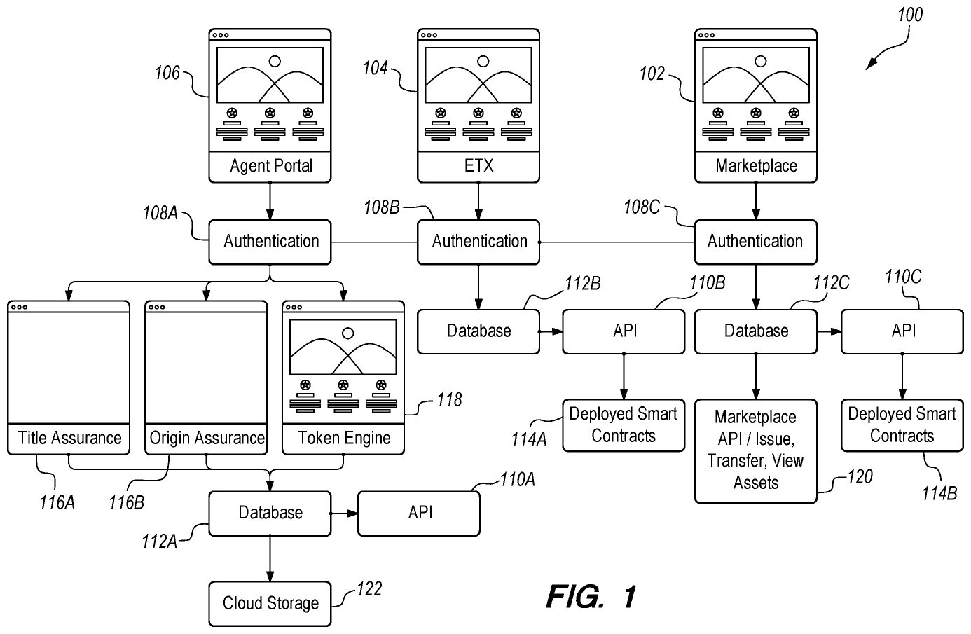

FIG. 1 is block diagram of one embodiment of an integrated ecosystem 100 of financial services utilizing blockchain technology. The integrated ecosystem 100 may be implemented on a host system and a network of devices. The host system can include a host processor, a host database, and a non-transitory computer-readable medium comprising code, executable by the host processor. It is understood that the integrated ecosystem and host system can include additional systems, subsystems and elements than those specifically shown and/or described herein. Additionally, or alternatively, the ecosystem and host system can omit one or more of the systems, subsystems and elements that are specifically shown and/or described herein.

As illustrated in FIG. 1, the integrated ecosystem 100 may include a marketplace client 102, an electronic exchange client 104, and an agent portal 106. The ecosystem may further include an authentication element 108 that can be commonly shared between each subsystem of the integrated ecosystem 100.

In one embodiment, the authentication element 108 may include encryption, firewalls, user passwords, and two-factor authentication such as Google Authenticator™. If the user successfully meets the requirements of the authentication element 108, the user will have access to the remainder of the elements of the system or subsystem to which the authentication element 108 is connected. The authentication element 108 can also integrate Firebase™ Authentication which uses an internally modified version of script to hash account passwords. The authentication element 108 can be multiple elements as shown in FIG. 1 as three elements, 108A, 108B, 108C. Alternatively the authentication element 108 can be one singular element connected to all of the other elements in the integrated ecosystem 100. Still alternatively, the authentication element 108 can be connected to less than all of the other elements in integrated ecosystem 100 and authentication element 108 may only be connected to one other element. The authentication element 108 can include other elements, systems, subsystems, functionalities and modalities not specifically shown and/or described herein.

In another embodiment, the marketplace client 102 can be a user interface on an electronic device. The marketplace client 102 may include functionality including asset categories, user settings and/or options, product lists, product purchase options, product multi-media galleries, integrated origin and/or title assurance, and integrated point-of-sale or digital wallet systems. After a user satisfies the authentication element 108, the user will have access to the entirety of the marketplace client 102. The marketplace client 102 can include other elements, systems, subsystems, functionalities and modalities not specifically shown and/or described herein.

In some embodiments, the electronic exchange client 104 may be a user interface on an electronic device. After a user satisfies the authentication element 108, the user will have access to the entirety of the electronic exchange client 104. The electronic exchange client 104 allows a user to create representation equity tokens for a wide variety of mixed assets types. The mixed asset types, as a non-exclusive example can include automobiles, stocks, bonds, business ownership interests, collectibles, digital assets (such as cryptocurrencies), and/or real estate. The representative equity tokens, as blockchain-verified tokens, are proof of ownership of the underlying mixed asset types within the representative equity tokens. The electronic exchange client 104 may also allow a user to define the underlying assets and determine the weighting of assets in the portfolio similar to an exchange-traded fund (“ETF”) product. The electronic exchange client 104 can also allow the token creator to determine the total quantity and/or initial supply of issued tokens. The electronic exchange client 104 can include other elements, systems, subsystems, functionalities and modalities not specifically shown and/or described herein.

In one embodiments, the agent portal 106 can be a user interface on an electronic device. The agent portal 106 can facilitate consumer blockchain transactions that will be handled by registered agents. After an approved partner or brand satisfies the authentication element 108, the agent portal 106 allows the approved partner or brand to upload product details, assured title, or origin information to the blockchain. Customers of the approved partner or brand can verify the origin authenticity by scanning a product's QR code with an integrated digital wallet system. The agent portal 106 can include other elements, systems, subsystems, functionalities and modalities not specifically shown and/or described herein.

In other embodiments, the integrated ecosystem 100 can further include an application programming interface (API) 110. The application programming interface (API) 110 can include a set of functions and procedures that allow the creation of new applications that access the features, data or applications of the integrated ecosystem 100 and its various subsystems. One non-exclusive, non-limiting example of application programming interface (API) 110 may include user-added web addresses for real-time pricing data within the electronic exchange client 104. The application programming interface (API) 110 may also include support for older or legacy APIs for integration with legacy systems. Modern APIs can also be supported within the application programming interface (API) 110 and may include web or https as non-exclusive, non-limiting examples. The application programming interface (API) 110 can have multiple elements as shown in FIG. 1 as three elements, 110A, 110B, 110C. Alternatively the application programming interface (API) 110 can be one singular element connected to all of the other elements in the integrated ecosystem 100. Still alternatively, the application programming interface (API) 110 can be connected to less than all of the other elements in integrated ecosystem 100 and the application programming interface (API) 110 may only be connected to one other element. The application programming interface (API) 110 can include other elements, systems, subsystems, functionalities and modalities not specifically shown and/or described herein.

In various embodiments, the integrated ecosystem 100 can further include a database 112. The database 112 may be the host database on the host system as previous described. The database 112 can also be a single computer, a cluster of computers, a large mainframe, a minicomputer clusters, a group of servers functioning as a single unit, or a server coupled to a web server. The database 112 may also include a blockchain ledger of the current value of blockchain verified assets. In one embodiment, every element within the integrated ecosystem 100 may need to access the database 112. Alternatively, less than every element within the integrated ecosystem 100 may need to access the database 112. The database 112 can be multiple databases as shown in FIG. 1 as three databases 112A, 1128, and 112C. Alternatively, the database 112 can be one singular database connected to all of the other elements in the integrated ecosystem 100. Still alternatively, the database 112 can be connected to less than all of the other elements in integrated ecosystem 100 and the database 112 may only be connected to one other element. The database 112 can include other elements, systems, subsystems, functionalities and modalities not specifically shown and/or described herein.

Sometimes, the integrated ecosystem 100 may also include deployable smart contracts 114. A smart contract may control the execution of a transaction digitally by recording the terms of the transaction on the blockchain. Smart contracts may function as a trusted distributed application that gains its security/trust from the blockchain and the underlying consensus among peers. A smart contract may include data which is signed and has consensus associated with validation among nodes in the blockchain. This prevents the smart contract from being repudiated. In one embodiment, every element within the integrated ecosystem 100 may need a deployable smart contract 114. Alternatively, the integrated ecosystem 100 may need only one deployable smart contract 114. There can be two deployable smart contracts as shown in FIG. 1 114A and 114B. The deployable smart contract 114 can include other elements, systems, subsystems, functionalities and modalities not specifically shown and/or described herein.

One non-exclusive, non-limiting example including the use of deployable smart contracts 114 is within the electronic exchange client 104. In this non-exclusive, non-limiting example, a user can complete a form describing the deployable smart contract 114 including details such as the token trading symbol, the token name, and initial supply. The deployable smart contract 114 may include a serial number of a digital currency held on a blockchain.

In other embodiments, the user may also define assets for the deployable smart contract 114 to track. When all of the requisite information is provided to the deployable smart contract 114, the deployable smart contract 114 can be deployed to a blockchain. In some embodiments, when the deployable smart contract 114 is tokenized by the block chain, the token owner's address can be transferred to a third-party financial exchange to facilitate trade, investment and token/asset liquidity.

In one embodiment, the token owner may edit contract details after the deployable smart contract 114 is already deployed to the blockchain. In another embodiment, the deployable smart contract 114 can assist with price discovery, liquidity arbitrage, rebalancing, utilizing oracle API functionality, or other built-in call to popular pricing APIs.

In various embodiments, title assurance 116A is another non-exclusive, non-limiting example system that may be included in the integrated ecosystem 100. Ownership of a piece of land can be verified using the title assurance 116A system. In the title assurance 116A system, a buyer, a seller, a buyer's bank, a seller's bank, a blockchain record, and a current title/land registry can be integrated into the title assurance 116A system to verify and record title to a piece of real property. The data can be handed within the title assurance 116A system in a similar manner as the origin assurance system described above. Hashes can be made for the data stored in the database 112. Hash data may be stored on the blockchain for future verification of documents.

In one embodiment of the title assurance 116A system, a buyer can receive a title deed from a seller, the buyer can send payment to a verification company, the buyer may enter the seller's details and title deed details into the system, a company can return ownership details from the database 112, the blockchain and the title/land registry, and the buyer may confirm the seller's ownership of the property as valid or invalid. The seller can pay a verification company to upload property ownership details, the title deed can be recorded in the database 112, the blockchain and can be checked with title/land registry or the verification company stores the data on behalf of the title/land registry, and the seller's title deed can be verified as being valid and that the seller is the verified owner.

In another embodiment of the title assurance 116A system, an agent can login or register to use the title assurance 116A system, the agent can upload the asset title and associated ownership data, the agent can query the national or local land/home/asset registry, if the ownership data is invalid, a prompt warning of invalid data may be provided, if the ownership data is valid the valid data can be added to the blockchain with a cryptographic signature. A public user may also get access to the title assurance 116A system. The public user can query the blockchain, the public user can parse the blockchain asset title data, the public user can compare the blockchain asset title data to the official records blockchain data and cryptography, if the data does not match a prompt validation warning can be provided, if the data matches, a prompt valid ownership message is provided.

Sometimes, the integrated ecosystem 100 may also include origin assurance 116B. A goods or product owner can be verified and approved for access to the origin assurance system in order to verify the origin of the goods or product. The good or product owner may be able to provide details for verification by the origin assurance 116B system. After the details are provided, the data of the goods or product may be cryptographically hashed, signed and placed onto a blockchain. Similarly, the same data of the goods or product may be stored on the database 112. The origin assurance 116B system can generate a detailed URL and a QR code to place on the goods or product packaging. The QR code can be scanned to access the detail page on the web. The blockchain data may also be parsed and can be verified against the stored data in the database 112 when the detail page on the web is accessed. The web data may be verified if it matches the data that was originally placed and signed on the blockchain.

In various embodiments, the integrated ecosystem 100 can further include a token engine 118. The agent may help an asset owner create a tokenized security asset or equity asset. The tokens may represent a whole or fractional ownership in an asset issued on the blockchain in digital tokens. The asset and equity can be defined on the token engine 118. The token details can be defined on the token engine 118. The tokens can be issued onto the blockchain using a deployable smart contract. The token engine 118 can generate new smart contract tokens based on the defined token attributes. The newly issued smart contract's blockchain address may be recorded in the database 112. The issued tokens may be digitally transferred to the asset owner's pre-determined asset receiving address. The owner may also send the tokens to any other investors' digital asset receiving addresses. The owner can also send tokens to an exchange or marketplace to facilitate liquidity for the asset. The token engine 118 can include other elements, systems, subsystems, functionalities and modalities not specifically shown and/or described herein.

In one embodiment, the integrated ecosystem 100 can further include a marketplace API 120. The marketplace API can facilitate the tracking of issued and purchased assets within the integrated ecosystem 100. A user can issue, transfer, and/or view assets by utilizing the marketplace API 120. The marketplace API 120 can include other elements, systems, subsystems, functionalities and modalities not specifically shown and/or described herein.

Sometimes, a cloud storage 122 can be implemented within the integrated ecosystem 100. The cloud storage may provide storage of and access to data objects that can also be stored on the database 112. Generally, uploading, access and manipulation of data stored on a cloud storage 122 is conducted via an HTTP, FTP or similar network connection. Cloud storage 122 service providers include those service provides known to those having ordinary skill in the art. The cloud storage 122 can include other elements, systems, subsystems, functionalities and modalities not specifically shown and/or described herein.

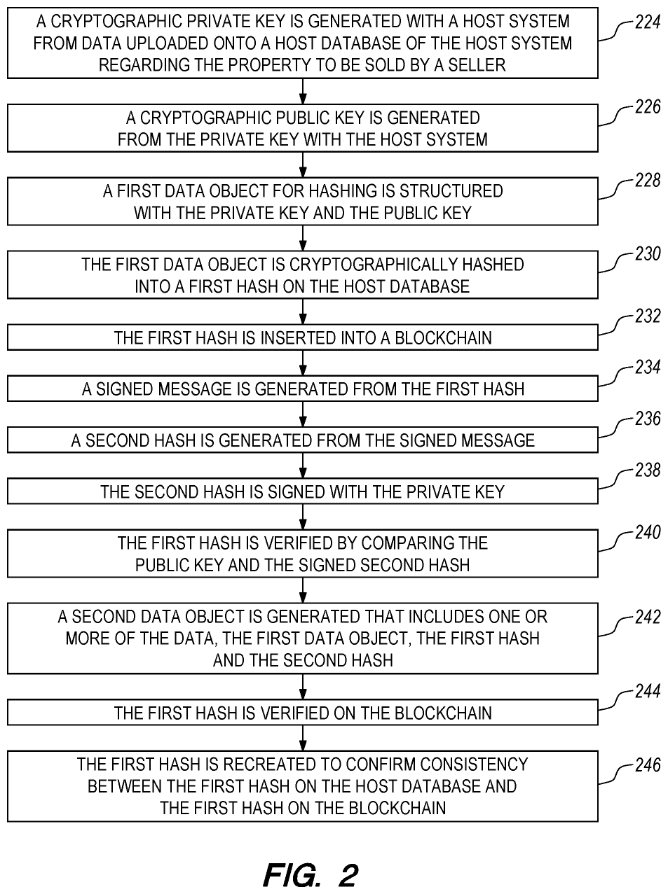

FIG. 2 is a flow chart depicting one embodiment of a method for authenticating the origin of property of a seller, which can include one or more of the following steps. It is understood that the method can include additional steps than those specifically shown and/or described herein. Additionally or alternatively, the method can omit one or more of the steps that are specifically shown and/or described herein. The method for authenticating the origin of property of a seller can be implemented on integrated ecosystem 100, or other systems and subsystems not specifically shown and/or described herein.

At step 224, a user (typically a potential seller) of the system can upload data into a host database of a host system. The host system can be the integrated ecosystem 100 or other systems and subsystems not specifically shown and/or described herein. The host database may be database 112, cloud storage 122 or another database, data server, cluster of servers, or cloud server system not specifically shown and/or described herein. The data includes information regarding the property to be sold or offered for sale. The data can include one or more of the type of property (i.e. personal or real), the specifics of the property, location of the property, etc., as non-exclusive examples. A cryptographic private key is generated by the host system from the data that is uploaded (input) in the host system. The cryptographic private key may be associated with a digital wallet or a chip on a smart card or a secure element of a user device. The cryptographic private key may also be kept secret and may be used to digitally sign messages sent to other users.

At step 226, a cryptographic public key is generated by the host system from the private key. The cryptographic public key may also be associated with a digital wallet. The cryptographic public key may serve as an address to receive signed message from other users.

At step 228, a first data object is structured with the private key and the public key. The first data object is structured for hashing. The user data uploaded onto the host system, the cryptographic private key, and the cryptographic public key may be bundled to together in the structure for hashing.

At step 230, the first data object is cryptographically hashed into a first hash on the host database of the host system. A hash can be generated from data of arbitrary size (e.g., a string of text). The hash may be, for example, a numerical or string value. The hash may be significantly smaller than the data itself. A hash may be generated by a function such that it is extremely unlikely that some other data will produce the same hash value, and it is extremely difficult to reconstruct the data based on the hash value.

At step 232, the first hash is inserted into a blockchain. The blockchain may be in a digital ledger that is on many computing devices. The transactions may be recorded on a set of blocks. Each block may contain a hash of one or more previous blocks. Accordingly, the record of each transaction cannot be altered retroactively without the alteration of all subsequent blocks and the collusion of the network. The first hash can be unique and may be used to verify the data from the first data object has not been changed or manipulated.

At step 234, a signed message is generated from the first hash.

At step 236, a second hash is generated from the signed message. The second hash may be in the form of a cryptographic signature.

At step 238, the second hash is signed with the private key.

At step 240, the first hash is verified by comparing the public key and the signed second hash. The authenticity of the message be verified using the public key and the signed second hash by matching the content of the first hash to the second hash.

At step 242, a second data object is generated that includes one or more of the data from host database, the first data object, the first hash and the second hash. The second data object may include an address, the cryptographic private key, an imageURL, the first data object, the first hash, and/or the second hash.

At step 244, the first hash is verified on the blockchain.

At step 246, the first hash is recreated to confirm consistency between the first hash on the host database and the first hash on the blockchain. The first hash may be added to the blockchain while simultaneously adding the updated data from the second data object to the database. After the first hash is added to the blockchain, the blockchain may generate a transaction ID. The second data object can be updated to include the transaction ID, a logo, and a company description prior to saving the second data object to the company database.

With the methods provided herein, the origin and/or authenticity of the property can be verified, assured or otherwise confirmed, or conversely is unverified or unconfirmed.

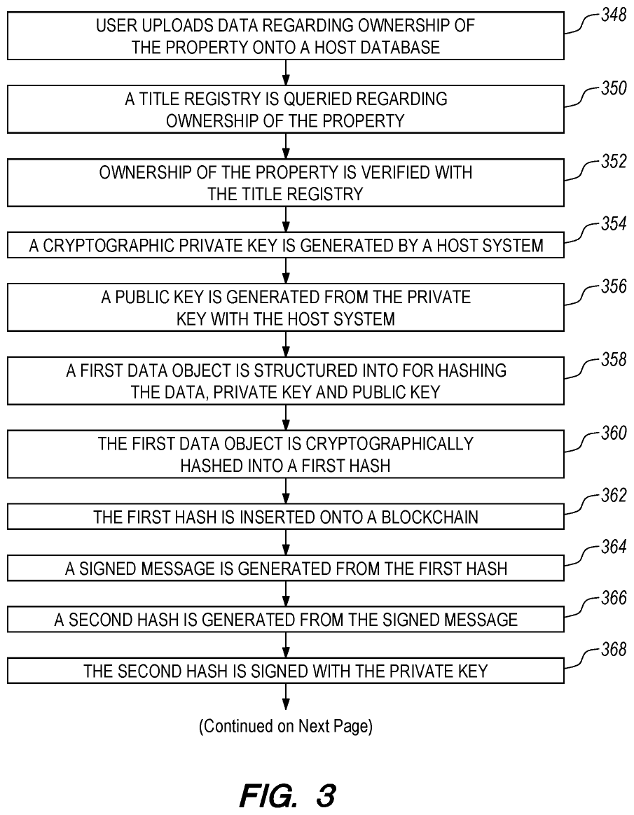

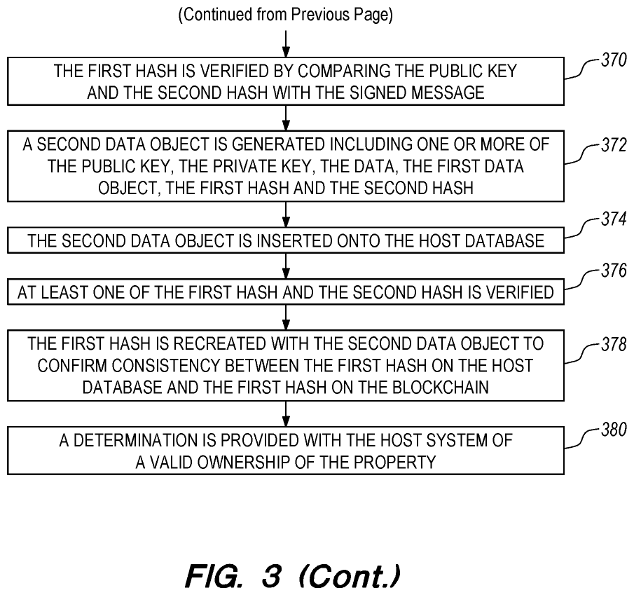

FIG. 3 is a flow chart depicting one embodiment of a method for verifying the title of property of a seller, which can include one or more of the following steps. It is understood that the method can include additional steps than those specifically shown and/or described herein. Additionally or alternatively, the method can omit one or more of the steps that are specifically shown and/or described herein.

At step 348, a user (typically a potential seller) of the system can upload data into a host database of a host system. The host system can be the integrated ecosystem 100 or other systems and subsystems not specifically shown and/or described herein. The host database may be database 112, cloud storage 122 or another database, data server, cluster of servers, or cloud server system not specifically shown and/or described herein. The data includes information regarding ownership of the property to be sold or offered for sale. The data can include one or more of the type of property (commercial, residential, etc.), the specifics of the property, location of the property, geographic coordinates, etc., or any other relevant information concerning the property, as non-exclusive examples.

At step 350, a title registry is queried regarding ownership of the property. The title registry can be from a local, state, federal or international administrative office, governmental agency, third-party Title Company or any other entity that maintains accurate title information on property.

At step 352, ownership of the property is verified (or conversely, not verified) with the title registry.

At step 354, a cryptographic private key is generated by the host system.

At step 356, a public key is generated by the host system from the private key.

At step 358, a first data object is structured for hashing the data, the private key and/or the public key.

At step 360, the first data object is cryptographically hashed into a first hash.

At step 362, the first hash is inserted into a blockchain.

At step 364, a signed message is generated from the first hash.

At step 366, a second hash is generated from the signed message.

At step 368, the second hash is signed with the private key.

At step 370, the first hash is verified by the comparing the public key with the signed second hash.

At step 372, a second data object is generated that includes one or more of the public key, the private key, the data that was uploaded into the host database of the host system, the first data object, the first hash and the second hash.

At step 374, the second data object is inserted onto the host database of the host system.

At step 376, at least one of the first hash and the second hash is verified.

At step 378, the first hash is recreated with the second data object to confirm consistency between the first hash on the host database and the first hash on the blockchain.

At step 380, a determination is made for whether the property at issue is validly owned by the user (or another). This determination is provided by the host system to the potential seller, a potential buyer, or any other interested person or entity.

With the methods provided herein, the title ownership and/or authenticity of the property can be verified, assured or otherwise confirmed, or conversely is unverified or unconfirmed.

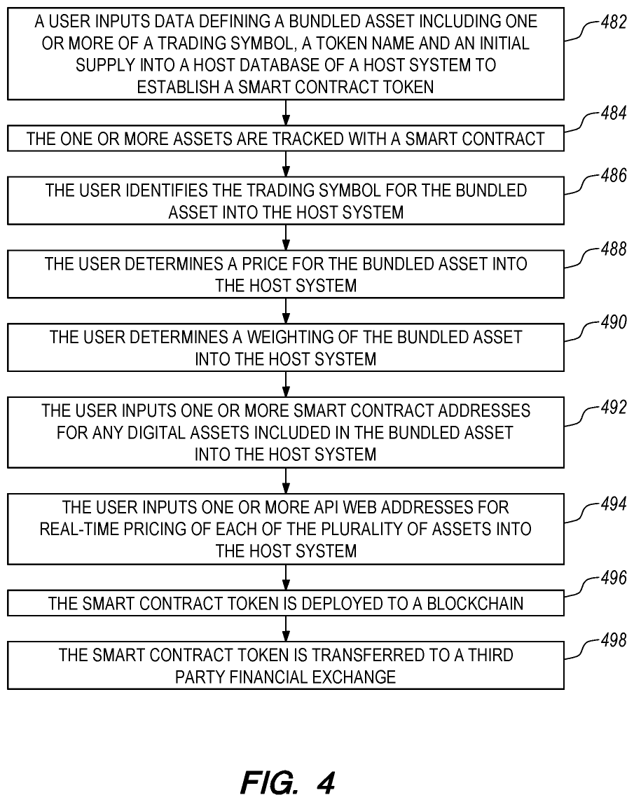

FIG. 4 is a flow chart depicting one embodiment of a method for generating specialized tokens for a bundled asset including one or more asset types.

At step 482, a user inputs data regarding a bundled asset onto a system database of the host system. The host system can be the integrated ecosystem 100 or other systems and subsystems not specifically shown and/or described herein. The host database may be database 112, cloud storage 122 or another database, data server, cluster of servers, or cloud server system not specifically shown and/or described herein. The bundled asset includes a plurality of assets. The data can include identifying the one or more assets that are included in the bundled asset. The specific assets can include, without limitation, any type or mix of assets, such as one or more types of digital currency such as cryptocurrency, real property, personal property, collectibles, one or more particular stocks, one or more types of bonds, gold bullion, etc., or any other type of asset or property. The data can also include, the type of each asset, a trading symbol for the bundled asset, and/or a token name for the bundled asset. The data input by the user establishes a smart contract token. The user can also input an initial supply of tokens for the bundled asset. For example, the user may wish to establish an initial supply of 20 tokens that would be for sale.

At step 484, the one or more assets, and thus, the bundled asset can be each tracked with the smart contract. For example, in one representative embodiment, the bundled asset can include 2 ounces of gold bullion, 1 bitcoin, 10 shares of Stock A, 10 shares of bond B, and a motorcycle. It is recognized that the foregoing example is but one of an infinite number of potential bundled assets that can be assembled and used with the systems and methods described herein.

At step 486, the user can identify the trading symbol for the bundled asset. The trading symbol may be a series of letters or an icon, as non-exclusive, non-limiting examples.

At step 488, the user can determine a price for the bundled asset and input the price into the host system. For example, the user can determine that the price for 100% of the bundled asset is $50,000.

At step 490, the user can determine a weighting of the bundled asset. For example, the user can determine that only 40% of the bundled asset is for sale to potential buyers. Thus, the total price for 40% of the bundled asset described at step 376 would be $20,000. In this non-exclusive embodiment, the user is offering 20 tokens for sale at a price of $1,000 each. In one embodiment the host system can mathematically calculate the price per token and display that amount to perspective buyers.

At step 492, in one embodiment, the user can input into the host system one or more smart contract addresses for any digital assets that may be included in the bundled asset.

At step 494, the user can input one or more API web addresses for real-time pricing of each of the plurality of assets into the host system so that the price for the bundled asset can change over time. Stated another way, the price for the bundled asset can be dynamic. In another embodiment, the price for the bundled asset can be time-stamped and can static.

At step 496, once all necessary information has been received by the host system, the smart contract can be deployed to a blockchain.

At step 498, the smart contract token can be transferred to a third-party financial exchange for facilitating trade, investment, token/asset liquidity and/or any other type of financial transactions.

With the technology provided herein, one or more of the following improvements can be realized: the integrated ecosystem simplifies the issuance, verification and management of created and purchased digital asset tokens. This end-to-end solution vastly improves blockchain financial services technology by improving the speed of tokenization and trading, increasing the security of integrated assets of different types by creating unique, verified tokens.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

It is understood that although a number of different embodiments of the systems and methods have been illustrated and described herein, one or more features of any one embodiment can be combined with one or more features of one or more of the other embodiments, provided that such combination satisfies the intent of the present invention.

While a number of exemplary aspects and embodiments of the systems and methods have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope, and no limitations are intended to the details of construction or design herein shown.

What is claimed is:

1. A method for generating specialized tokens for a bundled asset, the bundled asset including a plurality of assets, the method comprising the step of:
a user inputting data defining a bundled portfolio including one or more of a trading symbol, a token name and an initial supply into a host database of a host system to establish a smart contract token, the plurality of assets within the bundled asset are each tokenized and verified by utilizing a blockchain.

2. The method of claim 1 further comprising the step of tracking the bundled portfolio with a smart contract.

3. The method of claim 1 wherein the bundled portfolio includes a plurality of different types of assets.

4. The method of claim 1 further comprising the step of the user determining a price for the bundled portfolio into the host system.

5. The method of claim 1 further comprising the step of the user determining a weighting of the bundled portfolio into the host system.

6. The method of claim 1 further comprising the step of the user inputting one or more smart contract addresses for any digital assets included in the bundled portfolio into the host system.

7. The method of claim 1 further comprising the step of the user inputting one or more API web addresses for real-time pricing of each of the plurality of assets into the host system.

8. The method of claim 2 further comprising the step of deploying the smart contract token to the blockchain.

9. The method of claim 8 further comprising the step of transferring the smart contract token to a third-party financial exchange.

10. A host system for generating specialized tokens for a bundled asset, the bundled asset including a plurality of assets, the host system comprising:
a host processor;
a host database; and
a non-transitory computer-readable medium comprising code, executable by the host processor;
wherein the host system is configured to allow a user to input data defining a bundled portfolio including one or more of a trading symbol, a token name and an initial supply into the host database of the host system to establish a smart contract token, the plurality of assets within the bundled asset are each tokenized and verified by utilizing a blockchain.

11. The host system of claim 10 wherein the host system is configured to track the bundled portfolio with a smart contract.

12. The host system of claim 10 wherein the bundled portfolio includes one or more non-currency assets.

13. The host system of claim 10 wherein the host system is configured to allow the user to determine a price for the bundled portfolio and set the price for the bundled portfolio into the host system.

14. The host system of claim 10 wherein the host system is configured to allow the user to determine a weighting of the bundled portfolio into the host system.

15. The host system of claim 10 wherein the host system is configured to allow the user to input one or more smart contract addresses for any digital assets included in the bundled portfolio into the host system.

16. The host system of claim 10 wherein the host system is configured to allow the user to input one or more API web addresses for real-time pricing of each of the plurality of assets into the host system.

17. The host system of claim 11 wherein the host system is configured to deploy the smart contract token to the blockchain.

18. The host system of claim 17 wherein the host system is configured to transfer the smart contract token to a third-party financial exchange.

19. The host system of claim 11 wherein the plurality of assets includes at least one digital asset.

20. A host system for generating specialized tokens for a bundled asset, the bundled asset including a plurality of assets, the host system comprising:
a host processor;
a host database; and
a non-transitory computer-readable medium comprising code, executable by the host processor, for implementing a method comprising:
a user inputting data into the host database of the host system regarding the bundled asset including information regarding one or more of:
the specific assets included in the bundled asset, a trading symbol for the bundled asset, a token name for the bundled asset, and a quantity of an initial supply of tokens, the data establishing a smart contract token;
tracking the bundled asset with a smart contract;
the user identifying the trading symbol for the bundled portfolio into the host system;
the user determining a price for the bundled portfolio into the host system;
the user determining a weighting of the bundled portfolio into the host system;
the user inputting one or more smart contract addresses for any digital assets included in the bundled portfolio into the host system;
the user inputting one or more API web addresses for real-time pricing of each of the plurality of assets into the host system;
deploying the smart contract token to the blockchain; and
transferring the smart contract token to a third-party financial exchange.
